(19) United States
(12) Patent Application Publication
(10) Pub. No.: US 2011/0088325 A1
(43) Pub. Date: Apr. 21, 2011

(54) Motor Vehicle Door Comprising a Window-Lifting Rail Retained by a Module Support

(75) Inventors: Eric Zimmerman, Kassel (DE); Enrico Schliwa, Lauchroden (DE); Thomas Schmelz, Niestetal (DE)

(73) Assignee: FAURECIA INNENRAUM SYSTEME GMBH, Hagenbach (DE)

(21) Appl. No.: 12/972,150

(22) Filed: Dec. 17, 2010

Related U.S. Application Data
(63) Continuation of application No. 10/519,768, filed on Nov. 17, 2005.

(30) Foreign Application Priority Data
Jul. 1, 2002 (DE) 102 30 073.9

(51) Int. Cl. B60J 5/04; B60J 1/17; B60J 9/00

(52) U.S. Cl. 49/70; 49/502

(57) ABSTRACT

The invention relates to a motor vehicle door comprising a window pane that is movable therein and at least one window-lifting rail for guiding the window pane. A module support receiving elements such as loudspeakers or similar is disposed in the interior space of said motor vehicle door. Said module carrier and/or window-lifting rail is/are provided with at least one seat so as to retain the window-lifting rail in a non-positive manner within the module support.

### CROSS REFERENCE TO RELATED APPLICATIONS

This application is a continuation of co-pending U.S. patent application Ser. No. 10/519,768, which is a U.S. national phase of international patent application PCT/EP03/06993, filed on Jul. 1, 2003 and which claims priority to German patent application number 102 30 073.9, filed on Jul. 1, 2002, all of which are incorporated by reference.

### BACKGROUND OF THE INVENTION

The present invention relates to a motor vehicle door.

Various construction shapes of motor vehicle doors are known. Thus e.g. motor vehicle doors with a windowpane movable therein, as well as at least one window-lifting rail for guiding the windowpane is known.

Furthermore, it is known to attach a module support, mostly of plastic, in the inside of the motor vehicle door, on which various functional elements may be commonly accommodated, such as e.g. loudspeakers etc. This module support furthermore serves for separating the wet region from the dry region of the inner space of the door which is directed towards the interior.

Even if the module support has already effected a considerable reduction of the assembly expense, in operative combination with the at least one window-lifting rail there continues to exist a considerable assembly expense. Usually the at least one window-lifting rail is coupled onto the module support (quasi as a transport securement) with several screws. The actual assembly of the window-lifting rail is then effected via several screws onto the mostly metallic base structure of a door, and specifically onto the so-called “door inner panel” on which also the module support is usually fixed.

### BRIEF SUMMARY OF THE INVENTION

It is the object of the present invention to provide a motor vehicle door which has a reduced assembly expense compared to known motor vehicle doors and is therefore more economical in manufacture.

This object preferably is achieved by the characterizing features of the present invention.

By way of the fact that with a motor vehicle door of the known type, the module support and/or the window-lifting rail comprises at least one receiver for the positive-fit retention of the window-lifting rail in the module support, it is ensured that the window-lifting rail assumes a clearly defined position to the module support, which is essentially independent of additional non-positive fit elements, such as e.g. screws.

By way of the positive-fit accommodation, it is ensured that the window-lifting rail which also carriers the weight of the relatively heavy windowpane is held in the module support and is supported by this.

It is not necessary for the window-lifting rail to be supported perpendicularly to the vertical axis of the vehicle by an increased tightening of the screws or even for a fastening of the window-lifting rail having to be effected directly on elements of the door inner panel.

The advantages of the solution according to the invention lie in a considerable simplification of the assembly of the window-lifting system on the module support. At the same time the occurring forces are accommodated by the module support. A significant increase in the degree of integration on the module support and an increase of the net product which this entails are achieved.

Advantageous further embodiments of the present invention are specified in the dependent claims.

One advantageous embodiment of the invention envisages an additional screwing (screw connection) for fixing the window-lifting rail on the module support. By way of this one achieves a permanent fixation of the window-lifting rail on the module support, wherein this screwing usually does not need to accommodate weight forces of the window-lifting rail, but primarily those of the fixation in the horizontal directions (thus perpendicularly to the vertical axis of the vehicle). Here it lends itself to provide an inexpensive plastic direct screwing (self-cutting screws), i.e. here, the direction of the screws here may be effected in the direction of the vertical axis of the vehicle as well as also perpendicular to this or also in other spatial directions.

One particular advantageous formation envisages the window-lifting rail and/or the module support being provided with pins for the mutual centring and for the support of the window-lifting rail.

Here it is the case of exemplary elements for the positive-fit accommodation of the window-lifting rail in the module support. Of course it is also possible to support the window-lifting rail on shoulders of the module support or in pockets of the module support which are provided for this, in order thus to accommodate the forces of the window-lifting rail, in particular the vertical weight forces.

At the same time it is advantageous in each case for two pins to be provided for a window-lifting rail. At the same time it is favourable for a pin with an over-dimensioning to serve for the coarse positioning of the window-lifting rail with respect to the module support, and for the other to be with an exact positive fit for accommodating the vertical forces.

Various embodiments of the window-lifting rails are possible. Thus it is regularly envisaged for the window-lifting rails to run essentially vertically, i.e. in the direction of the vehicle vertical axis (under certain conditions with an inclination due to design). At the same time, one or also two window-lifting rails may be provided per motor vehicle door which serve for guiding or accommodating the weight of the window connected thereto.

At the same time various material embodiments are also possible. Thus it is possible for the window-lifting rails to be of metal, e.g. of sheet metal formed by deep-drawing procedures, i.e. steel sheet or also of die-cast aluminium. Alternatively it is also possible to design the window-lifting rails of plastic. The module support is regularly of plastic, here a PP-LGF (polypropylene long-fibre material) is suitable.

The inventive coupling between the window-lifting rails and the module support lends itself for various door concepts.

With one concept, the motor vehicle door comprises a base structure of deep-drawn sheet metal profiles, wherein an outer skin to the door closure towards the outside is given, and at least one door inner panel arranged closer towards the motor vehicle space is provided for fixing the module support. Here the door inner panel quasi represents the left peripheral regions, which “frames” the module support. The sealing against the penetration of fluid also takes place along this peripheral region. It is particularly advantageous with the invention that no direct connection needs to exist between the window-lifting rail and the door inner panel. This requirement would render the door inner panel more expensive in manufacture. The assembly of the module support would furthermore also become more difficult.

The concept according to the invention may however also be applied to other vehicle door types. For example doors exist which have a frame. With this in each case a panelling of the frame is provided on the outer side directed away from the motor vehicle interior as well as on the inner side arranged towards the motor vehicle interior. In this case the module support is fastened on the frame and the window-lifting rails may alone be fastened on the module support. A direct coupling of the window-lifting rails to the frame or parts of the panelling is not necessary.

Advantageous embodiments and further developments of the solution will be apparent from the description of the invention provided herein.

### BRIEF DESCRIPTION OF THE DRAWINGS

The invention is now explained in more detail by way of several Figures. There are shown in:

FIGS. 1a to 1d several views of a first embodiment of a motor vehicle door according to the invention,

FIG. 2 a plan view of a module support according to the invention, in the installed condition,

FIGS. 3a to 3c details of a second embodiment of a motor vehicle door according to the invention.

### DETAILED DESCRIPTION

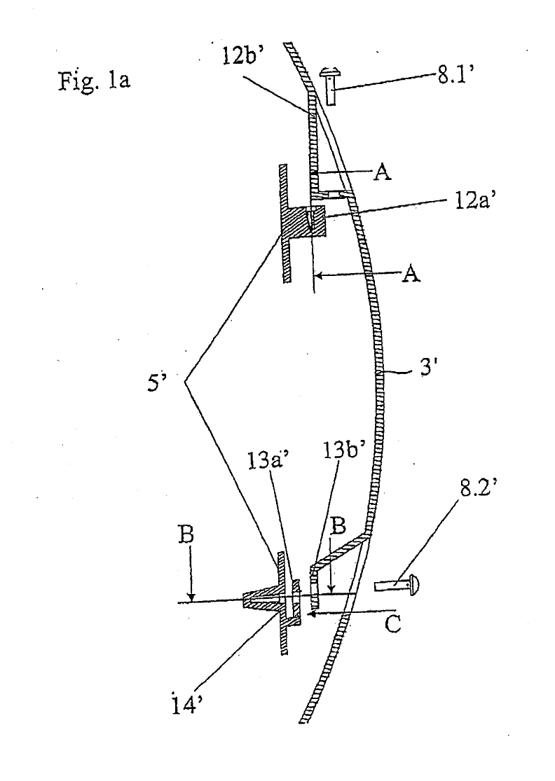

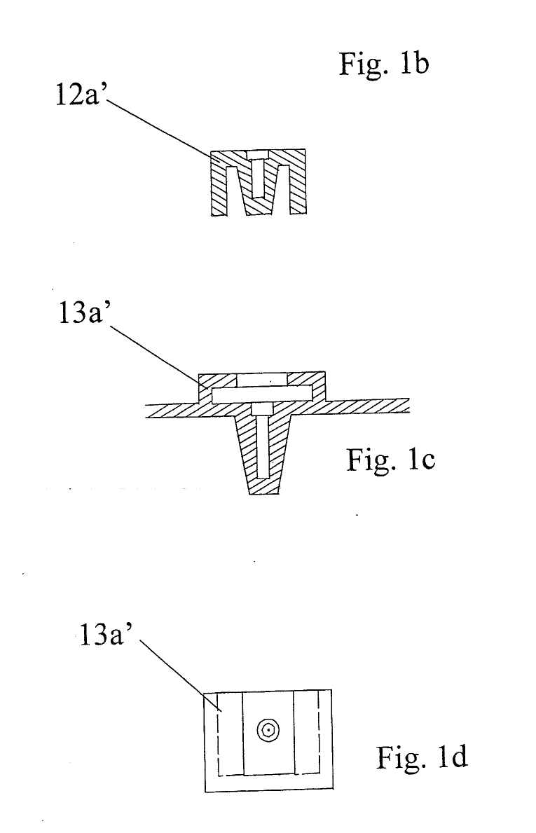

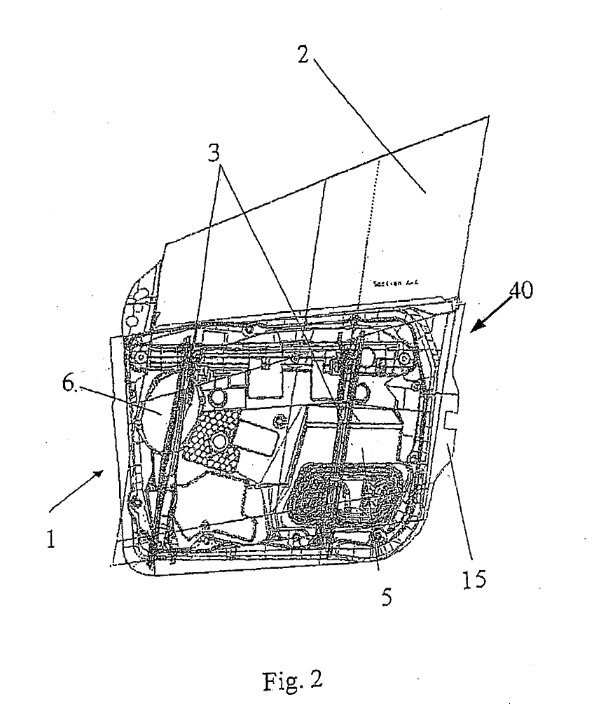

FIG. 1a shows the realisation of the invention with a first embodiment example of a motor vehicle door. Here are shown only cut-outs of a window-lifting rail 3′ which may be fastened on parts of a module support 5′. The module support 5′ comprises two receivers, wherein the first is designed as a projection 12a′ and the second as a pocket-like receiver 13a′. The receiver 12a′ comprises a vertically running bore, i.e. running in the vertical axis direction of the vehicle. For fastening the window-lifting rail 3′ directly on the module support 5′, a screw 8.1′ is stuck through a bore in the region 12b′ of the window-lifting rail 3′ and is screwed on the bore of the receiver 12a′. By way of the support of the step-like support 12b′ on the receiver 12a′, the vertical weight forces of the window-lifting rail 3′ are accommodated by the module support 5′

The window-lifting rail 3′ is additionally connected to the module support 5′ at a second location. For this, the module support 5′ comprises a pocket-like receiver 13a′. A projection 13b′ which projects in a lower region of the window-lifting rail 3′ may be positioned into this pocket-like receiver. At the same time the weight forces of the rail 3′ are accommodated by way of the pocket-like shape of the receiver 13a′. The projection 13b′ as well as the receiver 13a′ comprise flush bores for leading through a screw 8.2′ which may be screwed in a pocket-like receiver 14′.

It is to be noted that the screwing (screw connection) here may be effected in any manner. The direction of the screwing may either be effected in the direction of the vertical axis (see 12a′) or also perpendicularly to this, thus horizontally (see 13a′). Metal or plastic screws may be provided as screws which e.g. may be screwed into the module support 5′ in a self-cutting manner.

FIG. 1b shows a section according to A-A through the receiver 12a′. FIG. 1c shows a section according to B-B through the receiver 13a′. Here there are further shown lateral guide rails for accommodating the projection 13b′. This detail is also evident from FIG. 1d (a view according to C).

FIG. 2 shows the total construction of a motor vehicle door according to the invention. This comprises a base structure 15 of deep-drawn sheet steel. A module support 5 is accommodated in the inner cavity 40 of this base structure, and this module support is attached on a door inner panel of the base structure 15 in a peripheral and fluid-tight manner. The module support comprises receivers for various function elements, e.g. for loud speakers 6. On that side of the module support which is distant to the motor vehicle interior there are attached two window-lifting rails 3. These are arranged essentially parallel to one another, and essentially in the direction of the vertical axis of the motor vehicle. The window-lifting rails serve for guiding the windowpane 2 via a slide or pull cable mechanism which are not represented in more detail. It is to be noted that with the door shown here, the window-lifting rails 3 are directly and exclusively attached on the module support 5 and not additionally on the door inner panel belonging to the base structure 15.

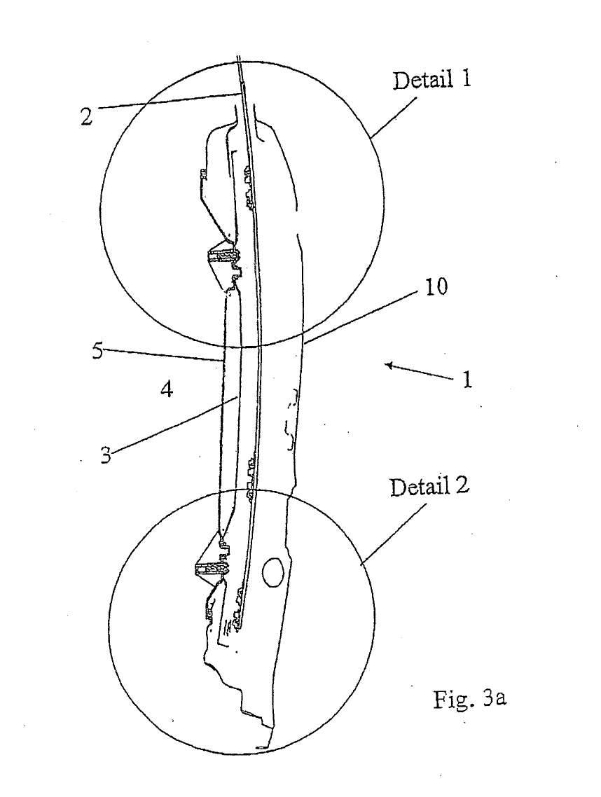

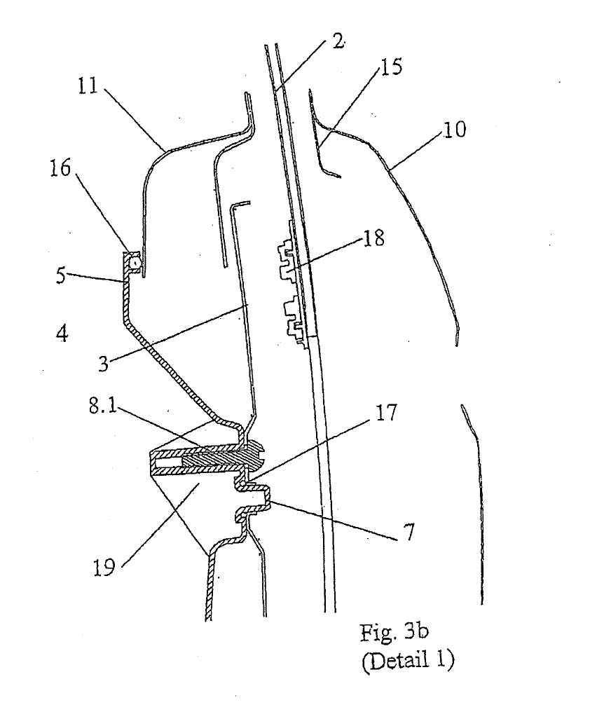

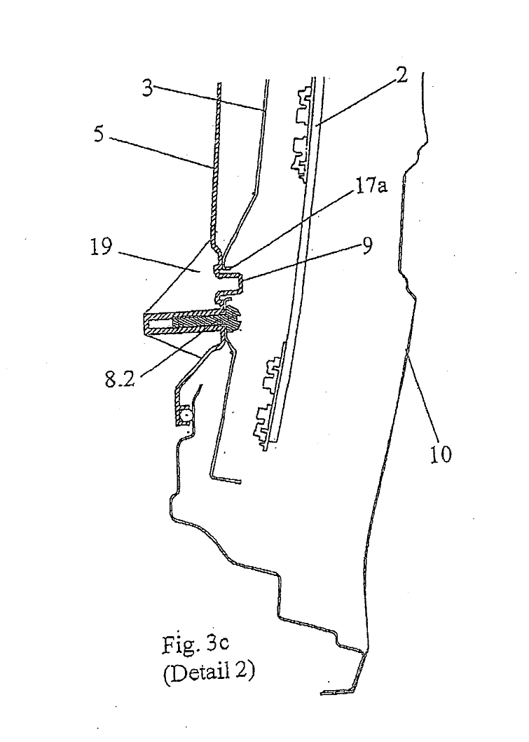

FIGS. 3a to 3c show a further embodiment of the motor vehicle door according to the invention.

FIG. 3a shows a section through a motor vehicle door 1 with a windowpane 2 which is movable therein as well as a window-lifting rail 3 for guiding the windowpane, and also with a module support 5 attached in the interior 4 of the motor vehicle door, for accommodating elements such as load speakers (see FIG. 2) or likewise. The window-lifting rail 3 is held in the module support 5 with a positive fit. Details of the fastening of the window-lifting rail and the module support are shown in Detail 1 (FIG. 3b) and Detail 2 (FIG. 3c).

FIG. 3b shows an enlarged representation of Detail 1 (see FIG. 3a). In this, one may recognise the base structure 15 of the motor vehicle door which consists of deep-drawn sheet sections. Thus this base structure comprises an outer skin 10 which forms the lateral closure of the door towards the outside. Furthermore the base structure 15 comprises a door inner panel 11 which runs in roughly the manner of a frame in the peripheral region of the base structure 15. The module support 5 comprises a sealing lip 16 which may be connected to the door inner panel 11 in an essentially peripheral manner. The window-lifting rail 3 in the installed position supports a windowpane 2 with a retention device 18 attached thereon for guiding or holding the windowpane 2 with respect to the window-lifting rail 3.

The window-lifting rail 3 is screwed to the support module 5 via a screw 8.1. For this the support module 5 comprises a pocket-like receiver consisting of plastic. The pocket-like receiver is connected to the remaining support module by way of a reinforcement strut. The window-lifting rail 3 comprises a hole-like receiver 17. This has an essentially round cross section. An essentially cylinder-shaped pin 7 is fitted into this receiver 17 with a positive fit so that the window-lifting rail 3 is positioned on the module support 5. The screw 8.1 at the same time assumes only the task of a fixation, i.e. the retention of the position. The accommodation with regard to weight is effected essentially via the pin 7.

FIG. 3c shows an enlarged view of the detail 2 (see FIG. 3a).

In this, the second fastening point is to be seen between the window-lifting rail 3 and the module support 5 of FIG. 3a. The window-lifting rail of FIG. 3a is essentially vertical, thus in the direction of the vehicle vertical axis, wherein in its upper section (see Detail 1) there is a fastening point and in its lower section a second fastening point (see Detail 2).

In FIG. 3c a screw 8.2 is also shown, which engages into a pocket-like receiver of the module support 5. A reinforcement rib 19 which is located in an essentially perpendicular manner on the base plane of the module support reinforces the pocket-like receiver. This rib furthermore runs through the pin 9 which likewise projects out of the module support base plane so that this on account of this is additionally reinforced (the same accordingly is also the case with the pin 7 of FIG. 3b). The pin 9 however, in contrast to pin 7, has an underdimension with respect to the corresponding receiver (here receiver 17a). By way of this it is possible during the assembly procedure to achieve a centring of the window-lifting rail. The actual retention or positioning is however effected via the pin 7. The screw 8.2, as already the screw 8.1, assumes only the task of horizontally fixing the window-lifting rail 3. The pin 7 achieves the retention task.

1. A motor vehicle door comprising a windowpane movable therein; at least one window-lifting rail for guiding the windowpane; and a module support attached in the interior of the motor vehicle door for accommodation of elements, wherein the module support comprises at least one receiver for the positive-fit retention of the window-lifting rail in the module support wherein the window-lifting rail assumes a clearly defined position in relation to the module support, where the receiver is a pin and the window-lifting rail is fixed to the module support by a screwing for retention purposes only, the weight of the window-lifting rail being supported essentially via the pin; and wherein the projection is an integral part of the module support and reinforced by a reinforcement rib.

2. A motor vehicle door according to claim 1, further comprising an additional screwing for the fixation of the window-lifting rail on the module support.

3. A motor vehicle door according to claim 1, wherein the module support comprises at least another pin for the mutual centring and for the support of the window-lifting rail.

4. A motor vehicle door according to claim 3, wherein in each case two pins are provided for a window-lifting rail.

5. A motor vehicle door according to claim 1, wherein one or two window-lifting rails per door are provided.

6. A motor vehicle door according to claim 1, wherein the window-lifting rail is of metal.

7. A motor vehicle door according to claim 1, wherein the module support is of plastic.

8. A motor vehicle door according to claim 1, wherein the door comprises a base structure of deep-drawn profiles, wherein an outer skin to the door closure to the outside is given, and at least one door inner panel is provided closer towards the motor vehicle interior, for fixing the module support.

9. A motor vehicle door according to claim 1, wherein the door comprises a frame, the frame comprising both a panelling at its side distant to the motor vehicle and its side facing the motor vehicle interior.

10. A motor vehicle door according to claim 1, wherein the elements are loud speakers.

11. A motor vehicle door according to claim 1, wherein the window-lifting rail comprises a hole-like receiver, the pin of the module support being fitted in the hole-like receiver for the positive fit retention.

12. A motor vehicle door according to claim 1, wherein the window-lifting rail is fixed to the module support by the screwing running in the direction of the pin into a bore of the module support.

13. A motor vehicle door according to claim 3, wherein the at least another pin is an integral part of the module support and reinforced by a reinforcement rib.

14. A motor vehicle door according to claim 3, wherein the window-lifting rail comprises a hole-like receiver and the at least another pin has an underdimension with respect to the hole-like receiver.
